(19) United States
(12) Patent Application Publication
(10) Pub. No.: US 2004/0021884 A1
(43) Pub. Date: Feb. 5, 2004

(54) Image processing method, image processing apparatus and storage medium

(75) Inventor: Takashi Hanamoto, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/620,688

(22) Filed: Jul. 17, 2003

(30) Foreign Application Priority Data
Jul. 30, 2002 (JP) 220662/2002

(51) Int. Cl. H04N 1/60

(52) U.S. Cl. 358/1.9; 382/167; 358/518

(57) ABSTRACT

JPEG image data is decoded into YCbCr data, an Exif tag is analyzed, and it is judged whether or not the image is to be emphasized in tonality according to the analyzed result. In case of tonality emphasis, the YCbCr data is converted into sRGB data, and the image data is corrected by an sRGB color space to perform conversion into DeviceRGB data. In case of color gamut emphasis, the YCbCr data is converted into XRGB data, and the image data is corrected by an xRGB color space to perform conversion into the DeviceRGB data. Then, the DeviceRGB data is converted into CMYK data to perform the print.

### BACKGROUND OF THE INVENTION

1. Field of the Invention

The present invention relates to an image processing method which is used to process a color image, an image processing apparatus which adopts the image processing method, and a storage medium which stores a program to achieve the image processing method.

2. Related Background Art

Usually, image data photographed or taken by a digital camera is stored as JPEG (Joint Photographic Expert Group) image data. FIG. 2 shows the flow of editing and printing for the JPEG image data.

In FIG. 2, in a step S201, the JPEG image data is read into a memory (the outline thereof will be described later). Then, in a step S202, a decode process is performed to the read JPEG image data to obtain eight-bit/three-component YCbCr data. In a step S203, a 3×3 matrix is applied to the YCbCr data to obtain eight-bit/three-component sRGB data. Continuously, in a step S204, each of R, G and B values of the sRGB data is displayed and is corrected. Finally, in a step S205, a print process is performed to the corrected SRGB data.

With the development of image pickup devices of the digital camera and image processing technology, the YCbCr data in the step S202 sometimes has a color gamut wider than that of an sRGB color space. In this case, a method of mapping data uncontainable within the region of the sRGB color space into a boundary of the sRGB color space is often adopted to cope with such a problem.

On one hand, a method of using such a wide color gamut as it is in a print process is sometimes adopted. That is, according to this method, in the step S203, the eight-bit YCbCr data is not converted into the eight-bit sRGB data but converted into another eight-bit color space (hereinafter, called XRGB data) having a color gamut wider than that of the sRGB color space, whereby the wide color gamut of the YCbCr data can be used in the print process as it is. However, in such a case, since the color gamut of the XRGB data is wider than that of the sRGB data though both the xRGB data and the sRGB data have eight bits, a problem that the tonality in case of printing the XRGB data deteriorates as compared with a case of printing the sRGB data occurs. Therefore, in case of printing the XRGB data, when a photographic object (i.e., object to be photographed) is a person, a problem that the tonality of skin (flesh color) of the person in question deteriorates may occur.

On the other hand, in case of printing the sRGB data, clearness in a scenery image and the like is lacked, whereby a problem that the color intended by a user cannot be reproduced in the print process may occur.

For these reasons, the user has to complicatedly perform the print process by appropriately selecting the color space suitable for the processed image.

### SUMMARY OF THE INVENTION

The present invention has been made in consideration of the above problems, and an object thereof is to provide an image processing method in which an appropriate color space is adopted according to a photographic object, an image processing apparatus to which the image processing method is applied, and a storage medium which stores a program to achieve the image processing method.

The above and other objects of the present invention will become apparent from the following detailed description in conjunction with the attached drawings.

### BRIEF DESCRIPTION OF THE DRAWINGS

FIG. 1 is a block diagram showing the system structure of the present invention;

FIG. 2 is the flow chart for explaining a printing method of a JPEG image;

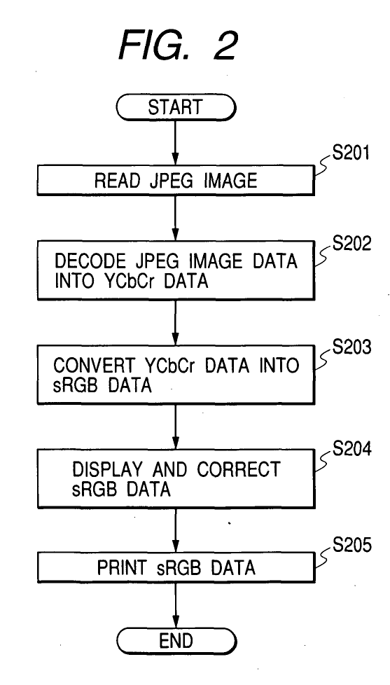

FIG. 3 is a diagram showing the structure of a digital camera;

FIG. 4 is a diagram showing the structure of a JPEG (Exif) file;

FIG. 5 is the flow chart for explaining a process of performing a print process for each color space in accordance with additional information;

FIG. 6 is the flow chart of a process of assigning image data for each color space;

FIG. 7 is the flow chart of a process of assigning the image data for each color space;

FIG. 8 is the flow chart of a process of performing a print process for each color space in accordance with an image analysis result;

FIG. 9 is the flow chart of a process of assigning the image data for each color space; and

FIG. 10 is the flow chart of a process of assigning the image data for each color space;

### DESCRIPTION OF THE PREFERRED EMBODIMENTS

Hereinafter, the embodiments of the present invention will be explained in detail with reference to the attached drawings. Here, the embodiment of switching a color space to be used in a print process according to photographing mode information described in a header of a JPEG (Joint Photographic Expert Group) file (Exif/DCF file) will be explained.

(First Embodiment)

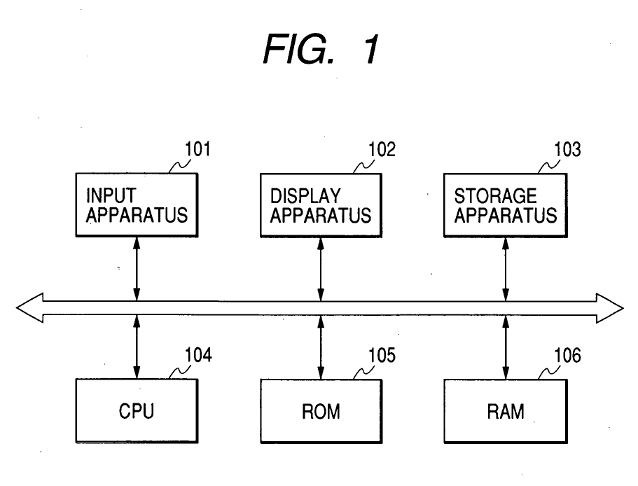

FIG. 1 is a block diagram schematically showing the structure of the first embodiment of the present invention. An input apparatus 101, which inputs instructions from a user and data, includes a pointing system such as a keyboard, a mouse and the like. A display apparatus 102 displays a GUI (Graphical User Interface), and a CRT, an LCD or the like is usually used for the display apparatus. A storage apparatus 103 stores image data and programs, and a hard disk is usually used for the storage apparatus. A CPU 104 performs an entire process of the above-mentioned each apparatus. A ROM 105 and a RAM 106 provide necessary programs and data and a work area to the CPU 104. It is assumed that control programs necessary in processes indicated in the following flow charts are stored in the storage apparatus 103 or the ROM 105. In a case where the programs are stored in the storage apparatus 103, the programs are once read into the RAM 106 and then performed.

It should be noted that, although an actual system includes various structural components other than such components as above, the explanation of these components will be omitted because they are not the central features of the present invention.

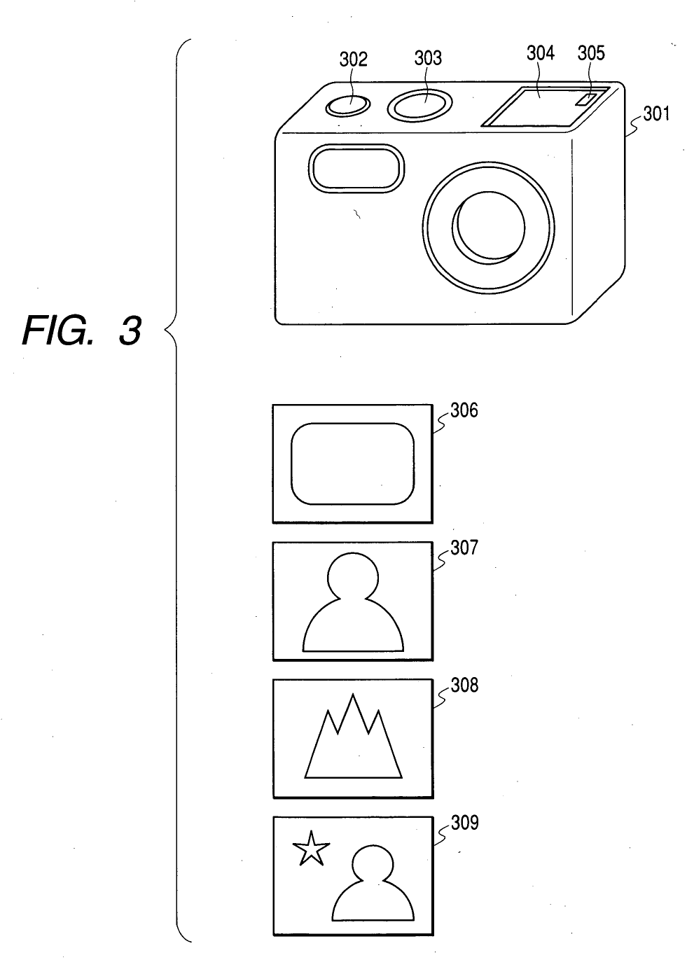

FIG. 3 is a diagram showing the schematic structure of a digital camera which records a photographed image after performing JPEG compression. A digital (still) camera 301 is equipped with a mode dial 303, whereby a mode in photographing can be changed by rotating the mode dial 303. Moreover, there are four kinds of photographing modes which consists of a person photographing mode 307 for photographing a person, a scene photographing mode 308 for photographing the scene, a night scene photographing mode 309 for photographing the night scene, and an automatic photographing mode 306 used for photographing the most part of the scene. These modes can be changed every time the mode dial 303 is rotated, and the currently selected mode is displayed as an icon of a selection mode 305 on an LCD panel 304. When depressing a shutter button 302, a JPEG image is photographed in the currently selected mode.

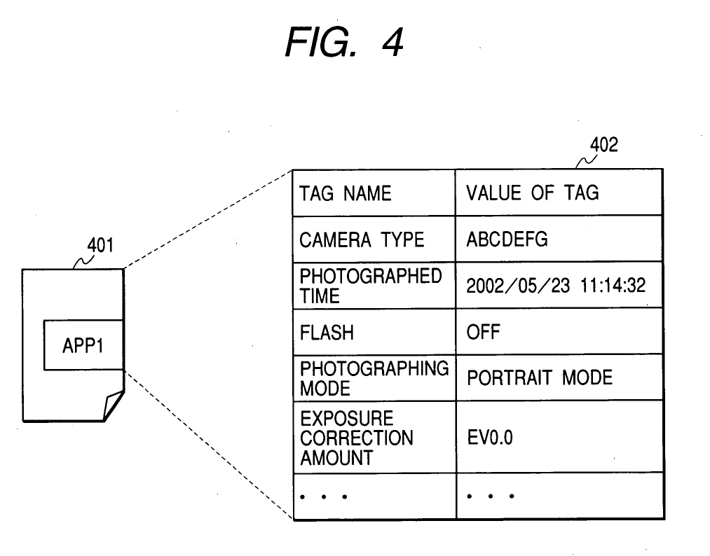

FIG. 4 is a diagram schematically showing the structure of the JPEG image photographed by the digital camera 301. The JPEG image photographed by the digital camera 301 is usually stored as a file format called an Exif. A data description space called APP1 (0xFFE1) Marker exists in a header of an Exif file 401, and information in photographing (model name, photographing time, photographing mode or the like) is described as Exif tag information 402 in APP1 Marker.

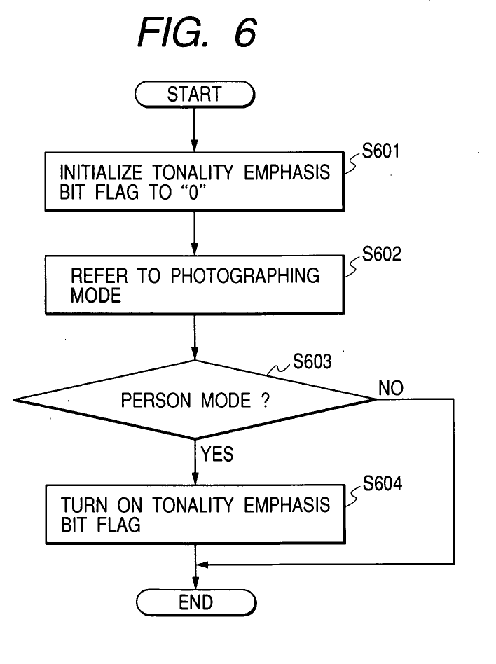

FIG. 6 is the flow chart showing a process of judging whether the JPEG image is to be emphasized in tonality or color gamut referring to the photographing mode. In a step S601, a tonality emphasis bit flag of judging whether or not the JPEG image is to be emphasized in tonality is formed on the RAM 106, and that flag is initialized to “0” (OFF). In a step S602, the photographing mode is referred by accessing to the JPEG image and a value of the mode is read. In a step S603, when the read photographing mode corresponds to a person mode, the flow advances to a step S604, and when the read photographing mode corresponds to modes other than the person mode, the process ends. In the step S604, the tonality emphasis bit flag is rewrite to “1” (ON) and then the process ends. Thus, when the photographing mode corresponds to the person mode, it is judged that the image is to be emphasized in tonality, and when the photographing mode corresponds to modes other than the person mode, it is judged that the image is to be emphasized in color gamut.

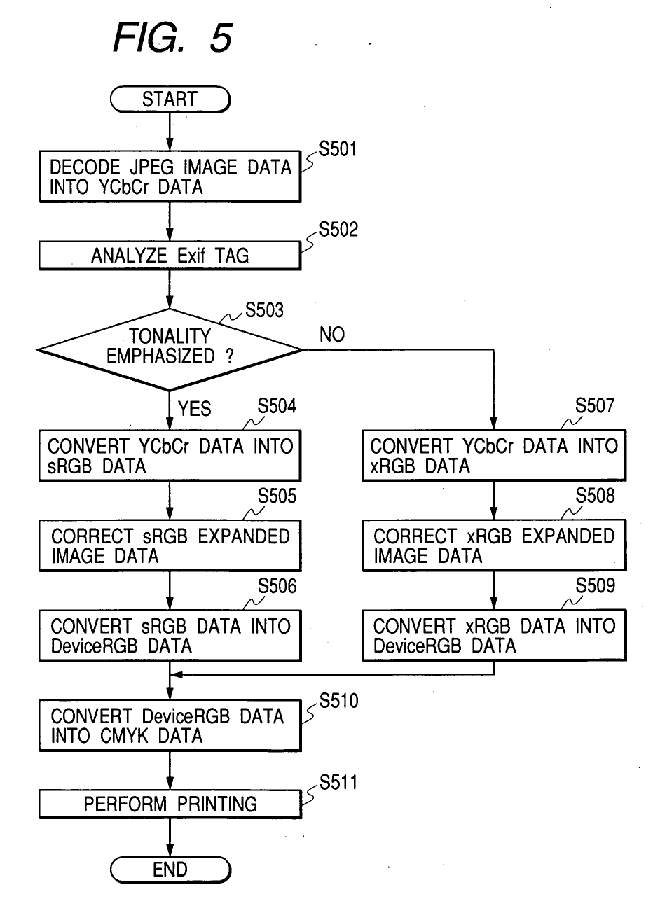

FIG. 5 is the flow chart showing a process of actually printing the JPEG image. In a step S501, the JPEG image data is read on the RAM 106 to decode it into eight-bit YCbCr data. The decoded YCbCr data is expanded on the RAM 106. In a step S502, an Exif tag is analyzed from the JPEG image data read on the RAM 106. In a step S503, it is judged whether or not the JPEG image data is to be emphasized in tonality from the analyzed Exif tag. This judgment process is same as that explained in the above with reference to FIG. 6.

When the image is to be emphasized in tonality, the flow advances to a step S504, while when the image is to be emphasized in color gamut, the flow advances to a step S507. In the step S504, the eight-bit YCbCr data is converted into eight-bit sRGB data. For this conversion, although a 3×3 matrix is generally used, another method of using a conversion table or an ICC profile is also available. In a step S505, the image data expanded into the sRGB data is corrected (modified) by using an automatic correction module or application. This correction may be automatically performed or manually performed by using the application software by a user. Here, it should be noted that any method is available in the correction.

In a step S506, the eight-bit sRGB data is converted into eight-bit DeviceRGB data to perform a color matching for the print. For this conversion, although a conversion table is generally used, another method of using the ICC profile or the like is available. In a step S510, the DeviceRGB data is converted into CMYK data matching with the print. In a step S511, the print is performed on the basis of the data converted into the CMYK data. In the step S507, since it is judged that the image is to be emphasized in color gamut, the eight-bit YCbCr data is converted into eight-bit xRGB data being a color space of having the color gamut wider than that of an sRGB color space. For this conversion, although a 3×3 matrix is generally used, another method of using the conversion table, the ICC profile or the like is also available. In a step S508, the image data expanded into the xRGB data is corrected (modified) by using the automatic correction module or the application software. This correction may be automatically performed or manually performed by using the application software by a user. It should be noted that any method is available in the correction. However, in case of the xRGB data, since there sometimes is a case where the image data cannot be displayed on the display apparatus 102, when the correction is manually performed by the user, the correction has to be performed under the condition that virtual color is displayed on the display apparatus 102.

In a step S509, the eight-bit xRGB data is converted into the eight-bit DeviceRGB data to perform a color matching for the print. For this conversion, although the conversion table is generally used, another method of using the ICC profile or the like is also available.

The process is sequentially continued to advance to the steps S510 and S511 after the processes in the steps S506 and S509 were performed.

In this manner, it is automatically judged whether the image is to be emphasized in tonality or color gamut by referring to the photographing mode of the Exif tag, thereby enabling to perform the print in a color space of matching with each of the images. It should be noted that the data called XRGB indicates a color space having an arbitrary space wider than that of the sRGB data, and any color space such as AdobeRGB(TM) or the like may be used as xRGB if it has a space wider than that of the sRGB data.

In the present embodiment, the data is converted into the eight-bit sRGB data only when the photographing mode corresponds to the person mode. However, it is available to convert the data into the sRGB data for another photographing mode emphasized in tonality.

It is also possible to set the correspondence between the photographing mode and color space conversion in accordance with the instruction from the user.

(Second Embodiment)

Then, the embodiment, where a JPEG image is printed upon judging whether the image is to be emphasized in tonality or color gamut from a photographing mode and other photographing information, will be explained. Since the system structure is same as that of the first embodiment, the explanation thereof will be omitted in the present embodiment.

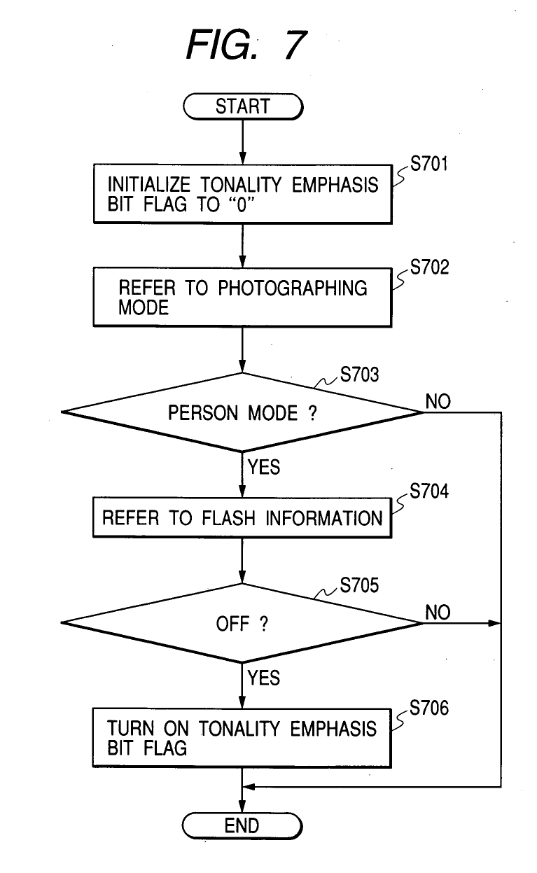

FIG. 7 is the flow chart showing a process of determining if the image is to be emphasized in tonality or the color gamut by referring to the photographing mode and flash information being one of Exif tag information (photographing information). In a step S701, a tonality emphasis bit flag of judging whether or not the image is to be emphasized in tonality is formed on the RAM 106, and that flag is initialized to “0” (OFF). In a step S702, photographing mode information is referred by accessing to the JPEG image and a value of the mode information is read.

In a step S703, when the photographing mode corresponds to a person mode, the flow advances to a step S704, while when the photographing mode corresponds to modes other than the person mode, the process ends. In the step S704, the flash information is referred. In a step S705, in a case of the flash-ON, it is judged that the image is to be emphasized in color gamut, and the process ends. This is because high possibility of a white blank (or white dot) for flesh color of a person being a photographic object is anticipated in a print process according to an sRGB color space in case of the flash-ON. In this case, the print for a region of the white blank can be appropriately performed by the print according to an xRGB color space. On the other hand, in case of the flash-OFF, the tonality emphasis bit flag is rewrite to “1” (ON) in a step S706, and then the process ends. In this manner, by using the photographing mode and the flash information, it is judged whether the image is to be emphasized in tonality or the color gamut.

Since the process of performing the print is same as that in the first embodiment, the explanation thereof will be omitted in the present embodiment.

In this manner, it is judged whether the image is to be emphasized in tonality or color gamut by utilizing the photographing mode and other photographing information, and it becomes possible to perform the print by a color space matching with each of the images according to the judgment result.

(Third Embodiment)

Subsequently, the embodiment, where a JPEG image is printed upon judging whether the image is to be emphasized in tonality or color gamut from additional information other than Exif photographing information, will be explained. Since the system structure is same as that of the first embodiment, the explanation thereof will be omitted in the present embodiment.

As the additional information to be added to the JPEG image, there are not only the Exif information described in the foregoing embodiments but also keywords of describing photographic object information, place information and/or event information, which are mainly utilized in the search. Among the above information, a person name can be described in the photographic object information. That is, from an inverse viewpoint, if the person name is added as a keyword, it is obvious that the person is recorded in the image.

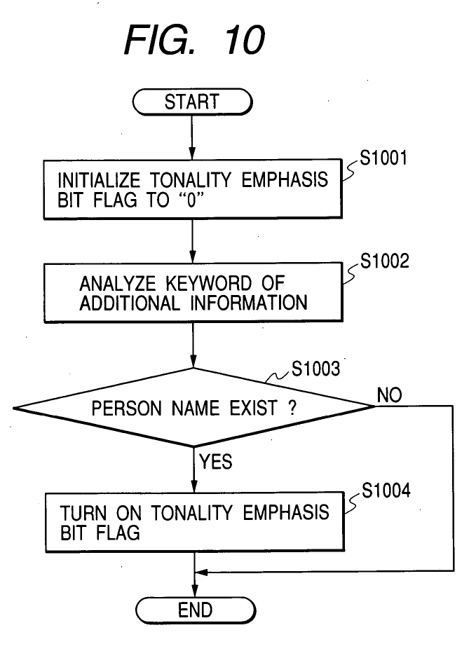

FIG. 10 is the flow chart showing a process of determining if the image is to be emphasized in tonality or color gamut by referring to the keyword in the additional information. In a step S1001, a tonality emphasis bit flag of judging whether or not the image is to be emphasized in tonality is formed on the RAM 106, and that flag is initialized to “0” (OFF). In a step S1002, the keyword in the additional information is referred by accessing to the JPEG image and a value of the information is read.

In a step S1003, in case of the person name is included in the read keyword, the flow advances to a step S1004, and in other cases, the process ends. In the step S1004, the tonality emphasis bit flag is rewrite to “1” (ON), and then the process ends.

In this manner, when the person name is included in the keyword in the additional information, it is judged that the image is to be emphasized in tonality, and when the person name is not included in the keyword in the additional information, it is judged that the image is to be emphasized in color gamut.

Since the process of performing the print is same as that in the first embodiment, the explanation thereof will be omitted in the present embodiment.

In this manner, it can be judged whether the image is to be emphasized in tonality or color gamut from the additional information other than the photographing information, and it becomes possible to perform the print by a color space matching with each of the images. At this time, it is also possible to judge whether the image is to be emphasized in tonality or color gamut by combining the photographing information with the other additional information. For example, if the photographing mode is set to an automatic mode, the image essentially has to be emphasized in color gamut. However, it is considered that in a case where the person name is included in the keyword in the additional information, the image is set to be emphasized in tonality.

(Fourth Embodiment)

The embodiment, where a JPEG image is printed upon judging whether the image is to be emphasized in tonality or color gamut by an analysis of the JPEG image without using additional information of the JPEG image, will be explained. Here, since the system structure is same as that of the first embodiment, the explanation thereof will be omitted in the present embodiment.

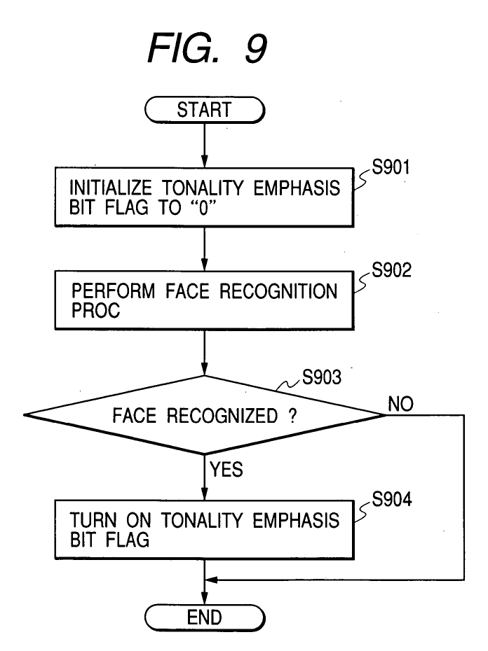

FIG. 9 is the flow chart showing a process of performing face recognition for an image and determining if the image is to be emphasized in tonality or color gamut according to the recognition result.

In a step S901, a tonality emphasis bit flag of judging whether or not the image is to be emphasized in tonality is formed on the RAM 106, and that flag is initialized to “0” (OFF). In a step S902, a face recognition process is performed to the image by accessing to the JPEG image.

When a face is recognized in a step S903, the flow advances to a step S904, and in other cases, the process ends. In the step S904, the tonality emphasis bit flag is rewrite to “1” (ON), and then the process ends.

In this manner, if the face is recognized as a result of the face recognition process, it is judged that the image is to be emphasized in tonality, and if the face is not recognized, it is judged that the image is to be emphasized in color gamut.

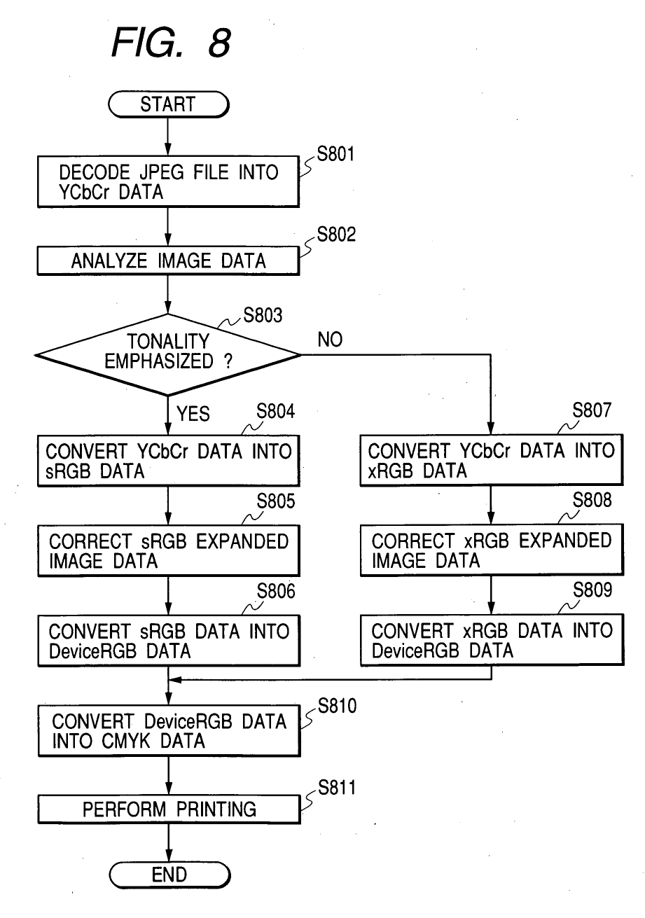

FIG. 8 is the flow chart showing a process of actually printing the JPEG image. In a step S801, the JPEG image data is read on the RAM 106 to decode it into eight-bit YCbCr data. The decoded YCbCr data is expanded on the RAM 106. In a step S802, a face region is detected from the JPEG image data read on the RAM 106.

In a step S803, it is judged whether or not the image is to be emphasized in tonality from a result of the face detection. A process of judgment is same as the process mentioned above with reference to FIG. 9. In case of the tonality emphasis, the flow advances to a step S804, and in case of the color gamut emphasis, the flow advances to a step S807. Since a process to be performed thereafter is same as that shown in FIG. 5, the explanation thereof will be omitted in the present embodiment.

In this manner, it can be judged whether the image is to be emphasized in tonality or color gamut from information other than the additional information of the image, and it becomes possible to perform the print by a color space matching with each of the images.

As means for analyzing the image, it is possible to use not only means for recognizing the face but also any means of capable of specifying, by detecting flesh color, that the photographic object is a person.

The embodiments of the present invention are explained by an example of the JPEG image. However, it is needless to say that another image format is available in an aspect of switching a color space to be used in printing according to the additional information.

As described above, the present invention has been explained on the basis of the preferable embodiments. However, the present invention is not limited to these embodiments, but may be modified in various manners within the scope of the claims.

What is claimed is:

1. An image processing method comprising:
an analysis step of analyzing additional information of input image data;
a selection step of selecting a color space conversion condition from among plural color space conversion conditions including first and second color space conversion conditions, in accordance with the analyzed result; and
a color space conversion step of converting a color space of the input image data by using the selected color space conversion condition,
wherein the first color space conversion condition and the second color space conversion condition are used to convert input color data into a different color space.

2. An image processing method according to claim 1, wherein a first color space conversion of using the first color space conversion condition is a conversion into an sRGB color space.

3. An image processing method according to claim 1, wherein a second color space conversion of using the second color space conversion condition is a conversion into a color space wider than the sRGB color space, and the bit number of the color data converted by the first color space conversion is same as the bit number of the color data converted by the second color space conversion.

4. An image processing method according to claim 1, wherein the additional information is information of indicating a photographing mode of the input image data.

5. An image processing method according to claim 1, wherein the additional information is flash information at a time of photographing the input image data.

6. An image processing method according to claim 1, wherein the additional information is photographic object information added to the input image data.

7. An image processing method according to claim 6, wherein the photographic object information is information of specifying that a photographic object is a person.

8. An image processing method according to claim 1, further comprising a correction step of performing an image correction for the image data, to which a color space conversion has been performed.

9. An image processing apparatus comprising:
analysis means for analyzing additional information of input image data;
selection means for selecting a color space conversion condition from among plural color space conversion conditions of including first and second color space conversion conditions, in accordance with the analyzed result; and
color space conversion means for converting a color space of the input image data by using the selected color space conversion condition,
wherein the first color space conversion condition and the second color space conversion condition are used to convert input color data into a different color space.

10. A computer-readable recording medium which records programs to execute the following steps of:
analyzing additional information of input image data;
selecting a color space conversion condition from among plural color space conversion conditions of including first and second color space conversion conditions, in accordance with the analyzed result; and
converting a color space of the input image data by using the selected color space conversion condition,
wherein the first color space conversion condition and the second color space conversion condition are used to convert input color data into a different color space.
